(19) United States
(12) Patent Application Publication
(10) Pub. No.: US 2026/0168401 A1
(43) Pub. Date: Jun. 18, 2026

(54) SYSTEM AND METHOD FOR CLEANING GAS TURBINE ENGINES

(71) Applicant: General Electric Company, Evendale, OH (US)

(72) Inventors: Rajanikanth G, Bengaluru (IN); Byron Andrew Pritchard, JR., Loveland, OH (US); Michael Edward Eriksen, Cincinnati, OH (US); Michael J. Gundrum, West Chester, OH (US); Nathan D. Tainter, Covington, KY (US); Krishna Ramadurai, Bengaluru (IN); John Ivor Gane, Caerphilly (GB)

(21) Appl. No.: 19/331,513

(22) Filed: Sep. 17, 2025

Related U.S. Application Data
(60) Provisional application No. 63/733,688, filed on Dec. 13, 2024.

(51) Int. Cl. F01D 25/00; B08B 9/032; B08B 9/035

(52) U.S. Cl. CPC F01D 25/002; B08B 9/0321; B08B 9/035

(57) ABSTRACT

A system for cleaning gas turbine engines includes a cleaning medium reservoir for storing a cleaning medium. The system further includes a delivery system configured to direct the cleaning medium from the cleaning medium reservoir towards one or more components of a gas turbine engine for cleaning the one or more components of the gas turbine engine. The system additionally includes a removal system configured to apply a vacuum pressure to the gas turbine engine for moving the cleaning medium through the gas turbine engine.

### CROSS-REFERENCE TO RELATED APPLICATION

The present application is based upon and claims the right of priority to U.S. Provisional Patent Application No. 63/733,688, filed Dec. 13, 2024, the disclosure of which is hereby incorporated by reference herein in its entirety for all purposes.

### FIELD

The present disclosure relates to gas turbine engines and, more particularly, to a system and related method for cleaning gas turbine engines, or components thereof.

### BACKGROUND

Typical aircraft propulsion systems include one or more gas turbine engines. For certain propulsion systems, the gas turbine engines generally include a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

During operation, a substantial amount of air is ingested by such gas turbine engines. However, such air may contain foreign particles. While a majority of the foreign particles will follow a gas path through the engine and exit with the exhaust gases, at least a portion of these particles may stick to certain components within the gas turbine engine's gas path, potentially changing aerodynamic and/or thermal properties of the engine, reducing engine performance, or even reducing engine life.

In order to remove such foreign particles from within the gas path of the gas turbine engine, a cleaning operation can be performed that directs water or other fluids towards an inlet of the gas turbine engine. However, such cleaning operations may require elongated soaking times or multiple cycles in order to sufficiently remove such foreign particles.

Accordingly, systems and methods for cleaning gas turbine engines that reduces cleaning time would be desirable in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a schematic cross-sectional view of a gas turbine engine in accordance with an exemplary aspect of the present disclosure.

FIG. 2 illustrates a schematic view of an exemplary cleaning system for cleaning gas turbine engines in accordance with an exemplary aspect of the present disclosure.

FIG. 3 illustrates a schematic diagram of a computing system for cleaning gas turbine engines in accordance with an exemplary aspect of the present disclosure.

FIG. 4 illustrates a flow diagram of one embodiment of a cleaning control algorithm for cleaning gas turbine engines in accordance with an exemplary aspect of the present disclosure.

FIG. 5 illustrates a flow diagram of one embodiment of a method for cleaning gas turbine engines in accordance with an exemplary aspect of the present disclosure.

Repeat use of reference characters in the present specification and drawings is intended to represent the same or analogous features or elements of the present technology.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a,” “an,” and “the” include plural references unless the context clearly dictates otherwise.

The term “at least one of” in the context of, e.g., “at least one of A, B, and C” refers to only A, only B, only C, or any combination of A, B, and C.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The terms “forward” and “aft” refer to relative positions within a gas turbine engine or vehicle, and are based on a normal operational attitude of the gas turbine engine or vehicle. More particularly, forward and aft are used herein with reference to a direction of travel of the vehicle and a direction of propulsive thrust of the gas turbine engine.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first,” “second,” and “third” may be used interchangeably to distinguish one component from another and are not intended to signify location or importance of the individual components.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

The present disclosure is generally related to gas turbine engines and, more particularly, to a system and related method for cleaning gas turbine engines. For instance, the present subject matter is directed to systems and methods for removing foreign particles from gas turbine engines, without requiring disassembly of cowls of the gas turbine engine, use of any gearboxes (e.g., accessory gearbox, transfer gearbox, and/or the like) of the gas turbine engine, or oil flooding procedures. More particularly, disassembly and reassembly of cowls of the gas turbine engines for cleaning processes requires a significant amount of time. Moreover, slow rotation of the gas turbine engines does not provide sufficient lubrication to gearboxes (e.g., accessory gearbox, transfer gearbox, and/or the like) of gas turbine engines, which can cause excess wear and damage to such gearboxes. In some situations, oil flooding of such gearboxes is performed to prevent such wear during cleaning processes, however draining the excess oil (e.g., 20 liters) after the cleaning processes significantly adds to the overall cleaning process, as it can take several hours (e.g., three to four hours). As such, the disclosed systems and methods remove the need to dissemble the cowls of the gas turbine engine and by-pass use of the gearboxes during cleaning.

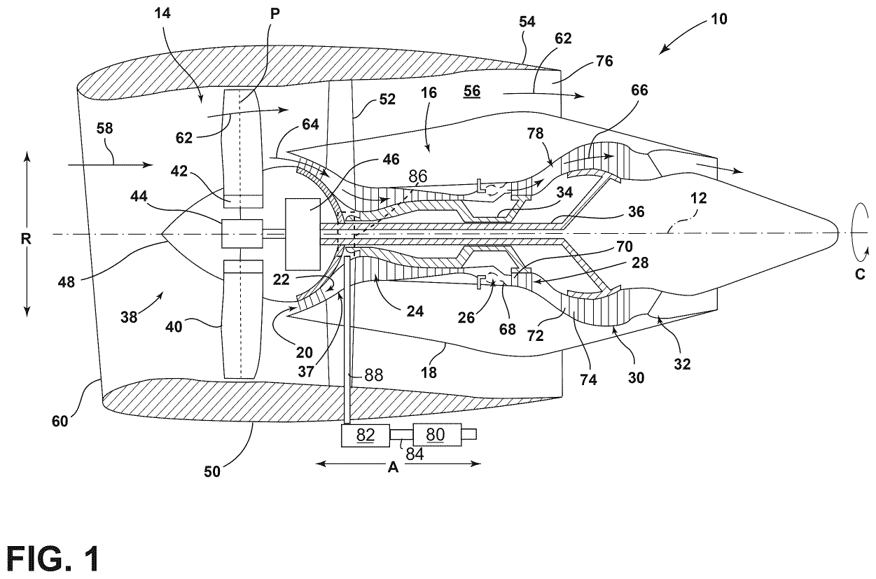

Referring now to the drawings, wherein identical numerals indicate the same elements throughout the figures, FIG. 1 illustrates a schematic cross-sectional view of a gas turbine engine 10 in accordance with an exemplary embodiment of the present disclosure. More particularly, for the embodiment of FIG. 1, the gas turbine engine 10 is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R (extending perpendicular to the longitudinal centerline 12), and a circumferential direction C extending about the longitudinal centerline 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a core gas flow path 37.

For the embodiment depicted, the fan section 14 includes a fan 38 having a plurality of fan blades 40 coupled to a disk 42 in a circumferentially spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 may further include (such as in a geared turbofan) a power gear box 46, and the fan blades 40, disk 42, and pitch change mechanism 44 are together rotatable about the longitudinal centerline 12 by the LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 is aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air (e.g., as indicated by arrow 58) enters the gas turbine engine 10 through an associated inlet 60 of the nacelle 50 and fan section 14. As the volume of air 58 passes across the fan blades 40, a first portion of the air (e.g., as indicated by arrow 62) is directed or routed into the bypass airflow passage 56 and a second portion of the air (e.g., as indicated by arrow 64) is directed or routed into the core gas flow path 37, or more specifically into the LP compressor 22. The ratio between the first portion of air 62 and the second portion of air 64 is commonly known as a bypass ratio. A pressure of the second portion of air 64 is increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

In some instances, the gas turbine engine 10 further includes an accessory gearbox 80 attached to the gas turbine engine 10. The accessory gearbox 80 may be mounted outside the flow paths of the gas turbine engine 10, e.g. coupled to the outer casing of the HP compressor 24, or to the nacelle 50 or any other stationary structure of the gas turbine engine 10. The accessory gearbox 80 may provide power to one or more suitable accessory systems of the gas turbine engine 10 during at least certain operations.

More specifically, the accessory gearbox 80 may be attached to the turbomachine 16 of the gas turbine engine 10, and is mechanically coupled to the HP shaft 34 of the turbofan engine 10. More particularly, the accessory gearbox 80 may be drivingly coupled to a transfer gearbox 82 via a transfer shaft 84, where the transfer gearbox, in turn, is coupled to an intermediate shaft 86. The intermediate shaft 86 is drivingly coupled to the HP shaft 34 directly or indirectly via an intermediate gearbox 86. The intermediate shaft 86 may extend through an outlet guide vane 52. The HP shaft 34 is rotatable with the intermediate shaft 86 (e.g., the transfer gearbox 82 and intermediate shaft 86 may rotate the HP shaft 34). An electric machine (i.e., a starter motor/generator) may be coupled to the accessory gearbox 80 for, e.g., starting the gas turbine engine 10 and/or generating electrical power once the gas turbine engine 10 is running.

It should be appreciated, however, that the exemplary gas turbine engine 10 depicted in FIG. 1 is by way of example only, and that in other exemplary embodiments, the gas turbine engine 10 may have any other suitable configuration. For example, although the gas turbine engine 10 depicted is configured as a ducted gas turbine engine (i.e., including the outer nacelle 50), in other embodiments, the gas turbine engine 10 may be an unducted gas turbine engine (such that the fan 38 is an unducted fan, and the outlet guide vanes 52 are cantilevered from the outer casing 18). Additionally, or alternatively, although the gas turbine engine 10 depicted is configured as a geared gas turbine engine (i.e., including the power gear box 46) and a variable pitch gas turbine engine (i.e., including a fan 38 configured as a variable pitch fan), in other embodiments, the gas turbine engine 10 may additionally or alternatively be configured as a direct drive gas turbine engine (such that the LP shaft 36 rotates at the same speed as the fan 38), as a fixed pitch gas turbine engine (such that the fan 38 includes fan blades 40 that are not rotatable about a pitch axis P), or both. It should also be appreciated, that in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, or a turbojet gas turbine engine.

In general, as indicated above, the volume of air 58 entering the gas turbine engine 10 through the associated inlet 60 of the nacelle 50 and the fan section 14 may contain foreign particles. While a majority of the foreign particles will follow the hot gas path 78 through the engine and exit with the exhaust gases or through the bypass airflow passage 56, at least a portion of these foreign particles may stick to certain components within the gas turbine engine 10, such as in the hot gas path 78 and/or the airflow passage 56, potentially changing aerodynamic and/or thermal properties of the engine, reducing engine performance, or even reducing engine life.

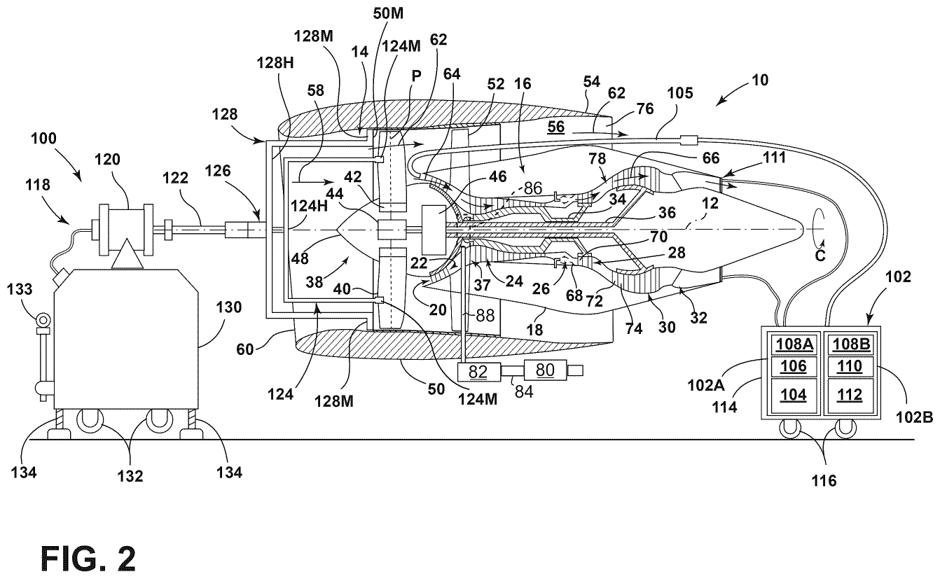

As such, referring now to FIG. 2, a schematic view of an exemplary cleaning system 100 for cleaning gas turbine engines is illustrated in accordance with an exemplary aspect of the present disclosure. It should be appreciated that, while the cleaning system 100 will be described with reference to the gas turbine engine 10 of FIG. 1, the cleaning system 100 may be suitable for use with any other suitable gas turbine engine.

In general, the cleaning system 100 is configured to remove foreign particles from gas turbine engines, such as the gas turbine engine 10, or components thereof, without requiring disassembly of cowls of the gas turbine engine 10, use of any gearboxes (e.g., accessory gearbox 80, transfer gearbox 82, intermediate gearbox 86, and/or the like) of the gas turbine engine 10, or oil flooding procedures. More particularly, disassembly of cowls (e.g., of the outer nacelle 50, of the outer casing 18, and/or the like) of the gas turbine engine 10 requires a significant amount of time for cleaning processes. In some instances, an electric machine (i.e., a starter motor/generator) may be coupled to the accessory gearbox 80 for, e.g., starting the gas turbine engine 10 and/or generating electrical power once the gas turbine engine 10 is running, where such electric machine may also be used to slowly rotate the gas turbine engine 10 during cleaning processes at speeds below the operational speeds of the gas turbine engine 10. However, slow rotation of the gas turbine engine 10 does not provide sufficient lubrication to gearboxes (e.g., accessory gearbox 80, transfer gearbox 82, intermediate gearbox 86, and/or the like) of the gas turbine engine 10, which can cause excess wear and damage to such gearboxes. In some situations, oil flooding of such gearboxes is performed to prevent such wear during cleaning processes, however draining the excess oil after the cleaning processes takes several hours. As such, the present cleaning system 100 avoids such issues.

For instance, the cleaning system 100 may include a cleaning medium system 102 configured to direct cleaning medium towards one or more components of the gas turbine engine 10 being cleaned and, in some instances, to help remove the cleaning medium from the gas turbine engine 10. For example, the cleaning medium system 102 may include one or both of a cleaning medium delivery system 102A and a cleaning medium removal system 102B.

The cleaning medium delivery system 102A may include one or more reservoirs 104, where each of the reservoirs 104 is configured to hold a cleaning medium. In some instances, for example, the cleaning medium(s) may include a detergent cleaning medium, such as a soap detergent that may be processed to become a foamed cleaning medium, a water-based cleaning medium, such as distilled water and/or de-ionized water, and/or the like. In some instances, the cleaning medium may include one or more particles configured to act as an abrasive cleaning medium. In some instances, the reservoir(s) 104 may be configured to hold a mixture of different cleaning mediums.

The cleaning medium delivery system 102A (hereinafter referred to as “delivery system 102A”) may include any suitable delivery devices for delivering the cleaning medium(s) from the reservoir(s) 104 to the gas turbine engine 10 in-situ, or components thereof. For instance, for delivering cleaning medium(s) in-situ, the delivery system 102A may inject the cleaning medium(s) at one or more locations of the gas turbine engine 10, such as at a gas turbine inlet (e.g., at the inlet 20, at an inlet at the combustion section 26, and/or the like), at one or more borescope ports of the gas turbine engine 10 (e.g., at one or more borescope ports of the compressor section, one or more borescope ports of the combustion section 26, and/or the like), at an existing baffle plate of the gas turbine engine 10, and/or any other suitable location. For instance, one or more injection tubes 105 may be inserted from the rear end of the gas turbine engine 10, between the outer nacelle 50 and the outer casing 18 for injecting cleaning medium(s) into the inlet 20 from a location rearward of the fan 38. In one or more instances, the injection tube(s) 105 may be shaped like a shepherd's hook, with the hook portion extending around the inlet 20. In some instances, the injection tube(s) 105 may be at least partially supported on one or more cowls of the outer casing 18 of the gas turbine engine 10. Therefore, the delivery system 102A is configured to introduce the cleaning medium into the gas turbine engine while the cowl(s) are still installed on the gas turbine engine 10 and closed, which reduces the time associated with performing the cleaning operation.

The delivery system 102A may include one or more pressure sources 106, such as one or more fans, one or more blowers, one or more pumps, and/or the like, for directing the cleaning medium(s) from the reservoir(s) 104 through the associated pipes, hose, conduits, tubing, and/or the like to the gas turbine engine 10, or components thereof. The delivery system 102A may further include, without limitation, one or more valves 108A selectively adjustable to direct cleaning medium(s) through the associated pipes, hose, conduits, tubing, or similar to the appropriate location(s) of the gas turbine engine 10, or components thereof. For instance, the valve(s) 108A may be adjustable to selectively supply detergent cleaning medium from the reservoir(s) 104 alone, water-based cleaning medium from the reservoir(s) 104 alone, or any suitable combinations thereof.

In some instances, the pressure source(s) 106 may pressurize the cleaning medium(s) for delivery. For instance, the detergent cleaning medium may be processed by the delivery system 102A to form a foamed cleaning medium for delivery. For example, the delivery system 102A may be configured to control the valve(s) 108A and the pressure source(s) 106 to mix detergent cleaning medium(s) from the reservoir(s) 104 with gas, such as air and/or inert gas, to generate a foamed detergent cleaning medium. As another example, the delivery system 102A may be configured to control the valve(s) 108A and the pressure source(s) 106 to distribute cleaning medium(s) from the reservoir(s) 104 at a particular flow rate.

Additionally, in some instances, the delivery system 102A may be configured to adjust the temperature of the cleaning medium(s) for delivery to the gas turbine engine 10. For instance, in some embodiments, the reservoir(s) 104 may be heated. Increasing the temperature of the cleaning medium(s) may improve the cleaning performance of the cleaning medium(s). For instance, the cleaning medium(s) may be supplied at a cleaning medium temperature(s) of between about 35 degrees Celsius and 100 degrees Celsius, such as between about 45 degrees Celsius and about 75 degrees Celsius, such as about 60 degrees Celsius. In such instances, the associated pipes, hose, conduits, tubing, and/or the like from the reservoir(s) 104 to the gas turbine engine 10 may be insulated to help maintain the desired cleaning medium temperature(s).

The cleaning medium removal system 102B (hereinafter referred to as “removal system 102B”) may similarly include any suitable devices for helping to remove used cleaning medium(s) from the gas turbine engine 10 in-situ, where the used cleaning medium(s) may include a mixture of the cleaning medium and residues removed from the gas turbine engine 10 by the cleaning medium. For instance, for removing the used cleaning medium(s) in-situ, the removal system 102B may apply a vacuum pressure at one or more location(s) of the gas turbine engine 10, such as at a gas turbine outlet (e.g., at the jet exhaust nozzle section 32, and/or the like), at one or more borescope ports of the gas turbine engine 10 (e.g., at one or more borescope ports of the compressor section, one or more borescope ports of the combustion section 26, and/or the like), at an existing baffle plate of the gas turbine engine 10, and/or any other suitable location.

The removal system 102B may include one or more pressure sources 110, such as one or more fans, one or more blowers, one or more pumps, and/or the like, for generating the vacuum pressure for helping move the cleaning medium(s) through and out of the gas turbine engine 10. The pressure source(s) 110 may be coupled by associated pipes, hose, conduits, tubing, and/or the like to a vacuum interface 111 couplable to the gas turbine engine 10. The vacuum interface 111 is, in some instances, couplable to the gas turbine engine 10 at the jet exhaust nozzle section 32, such as at and/or around the cowls of the outer casing 18 of the gas turbine engine 10. The vacuum interface 111 is configured to couple the gas turbine engine 10 to the pressure source(s) 110 such that the pressure source(s) 110 may apply the vacuum pressure to the gas turbine engine 10. In one or more instances, the vacuum interface 111 at least partially covers the jet exhaust nozzle section 32 and has one or more openings defined therethrough such that the cleaning medium(s) may flow out of the jet exhaust nozzle section through the openings defined in the vacuum interface 111. In some instances, the vacuum interface 111 is annular shaped plate received around the cowls extending radially inward of the jet exhaust nozzle section 32. The vacuum interface 111 may be detachably fixable to the outer casing 18, such as by bolts, screws, and/or the like. In some instances, the vacuum interface 111 creates a seal with the gas turbine engine 10 to improve the efficiency of the vacuum pressure generated through the gas turbine engine 10. The removal system 102B may further include, without limitation, one or more valves 108B selectively adjustable to apply the vacuum pressure at the gas turbine engine 10 and/or to direct used cleaning medium(s) through the associated pipes, hose, conduits, tubing, or similar away from the gas turbine engine 10. The removal system 102B may be configured to control the valve(s) 108B and the pressure source(s) 110 to remove the cleaning medium from the gas turbine engine 10 at a particular flow rate, such that the cleaning medium has at least a threshold minimum amount of time within the gas turbine engine 10 but is ultimately still removed from the gas turbine engine 10. For instance, in some instances, the removal system 102B generates a vacuum pressure in the gas turbine engine 10 at a pressure of about 1 inch of water, such as between about 0 inches of water (in-H₂O) and about 1 in-H₂O, such as between about 0.1 in-H₂O and about 0.5 in-H₂O, such as about 0.3 in-H₂O, and an air velocity of about 400 feet per minute (ft/min).

In some instances, the removal system 102B may include one or more reservoirs 112, where each of the reservoirs 112 is configured to receive the used cleaning medium that exits the gas turbine engine 10 during the cleaning process.

It should be appreciated that the various components of the cleaning medium system 102 (e.g., the reservoir(s) 104, 112, the pressure source(s) 106, 110, the valves 108A, 108B, and/or the like) may be supported on one or more wash carts 114. The wash cart(s) 114 may have a plurality of wheels 116, a handle (not shown), a propulsion motor (not shown), and/or the like to allow the wash cart(s) 114 to be moved to a desired location, such as proximate to the gas turbine engine 10. The wash cart(s) 114 may be modular to allow the different components stored thereon to be easily removable/replaceable or interchangeable.

It should also be appreciated that the various components of the cleaning medium system 102 (e.g., the valve(s) 108A, 108B, the pressure source(s) 106, 110, propulsion motor, and/or the like) may be manually controlled, automatically controlled, or a combination thereof.

In some instances, one or more components of the gas turbine engine 10 may be configured to be rotated during cleaning. In such instances, the cleaning system 100 may include an external drive system 118 for rotating the gas turbine engine 10 at speeds much lower than during normal operation, without causing damage to gearbox components of the gas turbine engine 10. For instance, the external drive system 118 may include one or more external rotation sources 120. The external rotation source(s) 120 may be configured to be rotatably coupled (directly or indirectly) to one or more components of the gas turbine engine 10 to rotate components of the gas turbine engine 10 during cleaning. The external rotation source(s) 120 may be any suitable external rotation device or combination of devices, such as an external motor(s), a blower(s), an air puller mechanism(s), and/or the like, not present for full operation of the gas turbine engine 10. For example, in some instances, the external rotation source(s) 120 is a motor configured to rotate a drive shaft 122, where the drive shaft 122 may be rotatably coupled (directly or indirectly) to one or more components of the gas turbine engine 10.

Particularly, the external rotation source(s) 120 may be rotatably coupled to the fan 38 of the gas turbine engine 10. For instance, the external drive system 118 may include a fan mount 124. The fan mount 124 rotatably couples the drive shaft 122 to the fan 38 of the gas turbine engine 10 for rotating the fan 38 during cleaning of the one or more components of the gas turbine engine. The fan mount 124 has at least two mounting arms 124M, each of the at least two mounting arms 124M being fixedly coupled to a respective fan blade 40 of the fan 38. The mounting arms 124M are coupled to a central hub 124H in a circumferentially spaced apart manner, and extend axially outwardly from the central hub 124H generally along the axial direction A. In some instances, the length of the mounting arms 124M in the axial direction A is selected such that the fan mount 124 may be coupled to the fan 38 without having to remove the front hub 48 of the fan 38. However, in some instances, the front hub 48 is configured to be removed such that the mounting arms 124M may be positioned radially closer to the disk 42 in the radial direction R, to reduce torque applied on the fan blades 40.

The mounting arms 124M may be evenly circumferentially spaced apart on the central hub 124H such that the weight of fan mount 124 is substantially evenly distributed for rotation. It should be appreciated that, while only two mounting arms 124M are shown, the fan mount 124 may have any other suitable number of mounting arms 124M, such as three, four, five, or more mounting arms 124M. In some instances, the mounting arms 124M may be coupled to the respective fan blades 40 by being received between two adjacent fan blades 40. In one or more instances, the mounting arms 124M may form a press fit between the two adjacent fan blades 40. In some instances, an axial end of each of the mounting arms 124M may define a channel in which a corresponding axial end of the respective fan blade 40 is receivable. In some instances, the mounting arms 124M are formed from a lightweight material, such as a plastic. However, in some instances, the mounting arms 124M may be formed of a metal, and/or any other suitable material or combinations of materials. In one or more alternate instances, the fan mount 124 may be coupled to the front hub 48 for rotation therewith to avoid applying torque on the fan blades 40. However, it is generally easier to couple the mounting arms 124M to the fan blades 40, because it is difficult to get sufficient friction on the front hub 48 to rotate the fan 38 at higher speeds.

The external drive system 118 may further include a fan coupling 126 configured to rotatably couple the drive shaft 122 to the fan mount 124. In one instance, the drive shaft 122 is coaxial with the longitudinal centerline 12, such that the drive shaft 122 and the fan 38 are together rotatable about the longitudinal centerline 12. However, in some instances, the shaft 122 may be offset from the longitudinal centerline 12. The fan coupling 126 may be configured to rotatably couple the drive shaft 122 to the fan mount 124 regardless of the alignment of the drive shaft 122 and the fan 38. In one or more instances, the drive shaft 122 may be a flexible shaft such that the drive shaft 122 may be coupled to the fan mount 124 while accounting for different relative positionings of the drive source 120 and the fan mount 124. In some instances, the fan coupling 126 includes a gearbox which may allow the fan 38 to rotate at a selected ratio relative to rotation of the drive shaft 122.

The external drive system 118 may further include a support frame 128 for rotatably supporting components of the external drive system 118 relative to the gas turbine engine 10. For instance, the support frame 128 may include at least two support arms 128M, each of the at least two support arms 128M being fixedly coupled to a portion of the gas turbine engine 10. In one instance, each of the support arms 128M is coupled to a respective portion of the outer nacelle 50 surrounding the fan 38. The support arms 128M may be coupled (directly or indirectly) to the outer nacelle 50 at a location within the outer nacelle 50, in front of at least a portion of the fan 38, such as rearward of at least a portion of the fan hub 48, at the inlet 60, and/or at any other suitable location on the outer nacelle 50. In some instances, the support arms 128M may be coupled to an inner housing 50M surrounding at least the fan 38, where the outer nacelle 50 is coupled to a radial exterior of such inner housing 50M, such that the support arms 128M are coupled indirectly to the outer nacelle 50. The support arms 128M may be detachably couplable (directly or indirectly) to the outer nacelle 50 using any suitable means, such as by screws, bolts, and/or the like. The support arms 128M are coupled to a support hub 128H in a circumferentially spaced apart manner, and extend axially outwardly from the support hub 128H generally along the axial direction A. The support arms 128M may be evenly circumferentially spaced apart on the support hub 128H such that the support frame 128 is substantially evenly distributed against rotation (e.g., rocking motion) relative to the gas turbine engine 10. It should be appreciated that, while only two support arms 128M are shown, the support frame 128 may include any other suitable number of support arms 128M, such as three, four, five, or more support arms 128M. The support frame 128 may be rigid and formed of a structural material, such as metal. However, it should be appreciated that the support frame 128 may be formed from any other suitable material for supporting rotation of the fan 38.

The external rotation source(s) 120 may be at least partially supported by the support frame 128. More particularly, in some instances, the drive shaft 122 may be rotatably supported by the support frame 128. For instance, the support frame 128 may define an opening through which the drive shaft 122 may extend and be supported for rotation relative thereto. In some instances, the fan coupling 126 may be mounted on the support frame 128, where the drive shaft 122 and/or the fan mount 124 are indirectly supported on the support frame 128 by the fan coupling 126 for rotation.

In general, the external drive system 118 is configured to allow the external rotation source(s) 120 (e.g., the drive motor) to drive rotation of the fan 38, which in turn rotates the LP shaft 36 for drivingly rotating the LP turbine 30 and the LP compressor 22 at rotational speeds below operational speeds of the gas turbine engine 10 without requiring use of any gearboxes of the gas turbine engine 10, which prevents damage of such gearboxes at such low speeds. For instance, the external rotation source(s) 120 may rotate the fan 38, and thus, the LP shaft 36, within a cleaning speed range, where the cleaning speed range is between about 2 revolutions per minute (rpm) and about 500 rpm, such as between about 5 rpm and about 100 rpm, such as between about 10 rpm and about 60 rpm. Such cleaning speed range is significantly lower than an operating speed range (e.g., above 1000 rpm, such as several thousand rpm) for operation of the gas turbine engine 10. The cleaning speed range may be limited depending on the type of cleaning medium being used. For instance, the cleaning speed range may be limited for foamed detergent cleaning mediums such that the foamed detergent cleaning medium does not collapse and allow for flow into bleed areas of the gas turbine engine 10. Moreover, the cleaning speed range may be limited depending on whether the rotation of the fan 38 is used with or without vacuum pressure of the removal system 102B. For example, in some instances, the cleaning speed range may be higher when used without vacuum pressure (e.g., between about 100 rpm and about 500 rpm) than with vacuum pressure (e.g., between about 10 rpm and about 60 rpm). Additionally, in some instances, the HP compressor 24 and the HP turbine 28 may be stationary during such rotation of the fan 38 and LP shaft 36, such that the gearboxes (e.g., accessory gearbox 80, transfer gearbox 82, intermediate gearbox 86) are also not rotated and are thus, protected against wear from insufficient lubrication during such cleaning processes.

It should be appreciated that various components of the external drive system 118 may be supported on a cart 130. The cart 130 may have a plurality of wheels 132, a handle 133, a propulsion motor (not shown), and/or the like to allow the cart 130 to be moved to a desired location, such as proximate to the gas turbine engine 10. In some instances, the cart 130 may include stabilization device(s) 134 which are controllable to help support the external rotation source(s) 120 during operation. For instance, the stabilization device(s) 134 may include retractable legs which may be extended to lift the cart 130 off the wheels 132, such that the cart 130 does not roll during operation of the external rotation source(s) 120. In some instances, the stabilization device(s) 134 may include wheel locks to prevent rotation of the wheels 132 during operation of the external rotation source(s) 120. However, it should be appreciated that the cart 130 may have any other suitable stabilization device(s) 134 or combinations thereof. It should further be appreciated that the cart 130 may be modular to allow the different components stored thereon to be easily removable/replaceable or interchangeable. In some instances, the cart 130 and the wash cart 114 may be combined.

It should additionally be appreciated that the various components of the external drive system 118 (e.g., the external rotation source(s) 120, stabilization device(s) 134, propulsion device(s), and/or the like) may be manually controlled, automatically controlled, or a combination thereof.

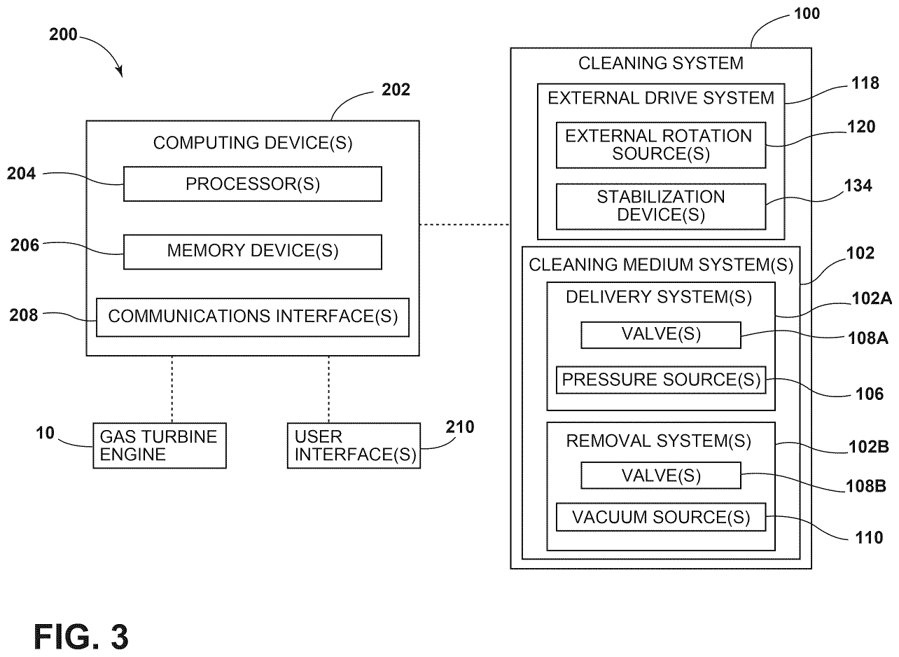

Referring now to FIG. 3, a schematic diagram of a computing system 200 for cleaning gas turbine engines is illustrated in accordance with an exemplary aspect of the present disclosure. In general, the computing system 200 will be described with reference to the gas turbine engine 10 described with reference to FIG. 1, and the cleaning system 100 described with reference to FIG. 2. However, it should be appreciated that the disclosed computing system 200 may be implemented with gas turbine engines and cleaning systems having any other suitable configurations.

In several embodiments, the computing system 200 may include one or more computing devices 202 and various other components configured to be communicatively coupled to and/or controlled by the computing device(s) 202. For instance, the computing system 200 may include one or more components of the cleaning system 100, such as the one or more components of the cleaning medium system(s) 102 (e.g., the valve(s) 108A, 108B, the pressure source(s) 106, 110, and/or the like), one or more components of the external drive system(s) 118 (e.g., the external rotation source(s) 120, the stabilization device(s) 134, and/or the like), one or more components of the gas turbine engine 10, one or more user interface(s) 210, and/or the like. It should be appreciated that the user interface(s) 210 described herein may include, without limitation, any combination of input and/or output devices that allow an operator to provide inputs to the computing device(s) 202 and/or that allow the computing device(s) 202 to provide feedback to the operator, such as a keyboard, keypad, pointing device, buttons, knobs, touch sensitive screen, mobile device, audio input device, audio output device, and/or the like.

In general, the computing device(s) 202 may correspond to any suitable processor-based device(s), such as a computing device or any combination of computing devices. Thus, as shown in FIG. 3, the computing device(s) 202 may generally include one or more processors 204 and one or more associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 206 may generally have memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 206 may generally be configured to store information accessible to the processor(s) 204, including data that can be retrieved, manipulated, created and/or stored by the processor(s) 204 and instructions that can be executed by the processor(s) 204.

The computing device(s) 202 may also include a communications interface 208 to provide a means for the computing device(s) 202 to communicate with any of the various system components described herein. For instance, one or more communicative links or interfaces (e.g., one or more data buses) may be provided between the communications interface 208 and any system components configured to carry out one or more of the elements of the disclosed method. For example, as illustrated, the computing device(s) 202 may be communicatively coupled via one or more communicative links or interface(s) to the cleaning system 100 (and/or individual components thereof), one or more components of the gas turbine engine 10, the user interface(s) 210, and/or the like.

It should be appreciated that in some instances, the computing device(s) 202 is a separate computing device communicatively coupled to an existing computing device for controlling the gas turbine engine 10 during normal operation. However, in some instances, the computing device(s) 202 is part of the existing computing device for controlling the gas turbine engine 10 during normal operation and configured to perform one or more of the functions described herein for cleaning operations.

In general, the instructions stored within the memory device(s) 206 of the computing device(s) 202 may be executed by the processor(s) 204 to implement a cleaning operation for cleaning gas turbine engines, such as the gas turbine engine 10. The computing device(s) 202 may generally control (directly or indirectly) the components of the cleaning system 100 to perform a cleaning operation. For instance, computing device(s) 202 may generally control (directly or indirectly) the components of the cleaning medium system(s) 102 to control movement of cleaning medium from the reservoir(s) 104 through the gas turbine engine 10 being cleaned and out of the gas turbine engine 10 and/or control (directly or indirectly) the external drive system 118 to rotate components of the gas turbine engine 10 during the cleaning operation as described above for performing the cleaning. In some instances, the computing device(s) 202 may be configured to automatically control the various components of the computing system 200 to perform a cleaning operation, such as in response to receiving an input indicative of a request to begin the cleaning process. However, in some instances, an operator may manually control various components of the computing system 200 to perform a cleaning operation.

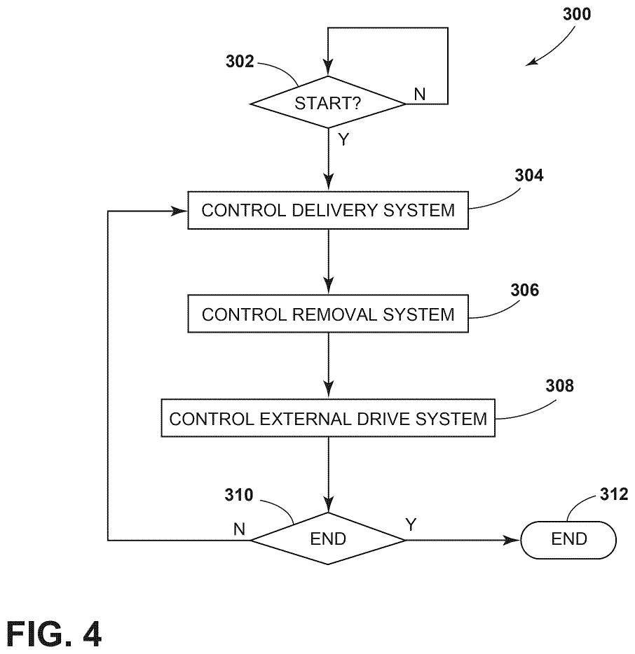

Referring now to FIG. 4, FIG. 4 illustrates a flow diagram of one embodiment of a cleaning control algorithm 300 for cleaning gas turbine engines in accordance with an exemplary aspect of the present disclosure. In general, while some parts of the cleaning control algorithm 300 will be described herein as being implemented by the computing device(s) 202 of the computing system 200 described above with reference to FIG. 3, it should be appreciated that the various processes described below may alternatively be implemented by another computing device or any combination of computing devices. In addition, although FIG. 4 depicts control steps or functions performed in a particular order for purposes of illustration, the steps or functions of the cleaning control algorithm 300 discussed herein are not limited to any particular order or arrangement. One skilled in the art, using the disclosures provided herein, will appreciate that the various steps or functions of the cleaning control algorithm 300 disclosed herein can be omitted, rearranged, combined, and/or adapted in various ways without deviating from the scope of the present disclosure.

Particularly, as shown in FIG. 4, the cleaning control algorithm 300 may include determining at (302) whether cleaning of a gas turbine engine, or part thereof, is to begin. For instance, the computing device(s) 202 may be configured to receive an input indicative of a request to begin cleaning the gas turbine engine 10. For example, the computing device(s) 202 may receive an input via the user interface(s) 210 indicative of a request to begin the cleaning process for the gas turbine engine 10. In some instances, the input may simply command that the cleaning process begin. In some instances, the input may indicate the degree of buildup at one or more locations of the gas turbine engine 10 and/or components thereof. For example, in some instances, the input may indicate a measured thickness and the location of the buildup, the operating time and/or operating conditions since the last cleaning operation, and/or the like. In some instances, the input may include a series of pictures, where the images may be analyzed by the computing device(s) 202 (e.g., by comparing the pictures to corresponding pictures of the clean gas turbine engine 10, or parts thereof) to determine the degree(s) and/or location(s) of buildup. In one or more instances, the input may indicate that one or more components of the cleaning system 100 is turned on (is online/powered), that one or more components of the cleaning system 100 is attached to the gas turbine engine 10 (or parts thereof), and/or the like. In some instances, the input may be received, at least in part, from the gas turbine engine 10 (e.g., from a computing system of the gas turbine engine 10).

Once it is determined at (302) that cleaning should begin, in some instances, the cleaning control algorithm 300 may include controlling, at (304), the delivery system 102A of the cleaning system 100 to direct at least one cleaning medium from at least one of the cleaning medium reservoirs 104 towards the gas turbine engine 10, or components thereof, to be cleaned. For instance, the pressure source(s) 106 and/or the valve(s) 108A of the delivery system 102A may be controlled (e.g., activated) by the computing device(s) 202 to direct the cleaning medium(s) into the gas turbine engine 10. The delivery system 102A may be controlled to supply the cleaning medium(s) into the gas turbine engine 10 for a predetermined amount of time, such as several hours (e.g., about four hours), at one or more predetermined intervals, and/or at predetermined flow rates.

In some instances, once it is determined at (302) that cleaning should begin, the cleaning control algorithm 300 may include controlling, at (306), the removal system 102B of the cleaning system 100 to generate a vacuum pressure to be applied to the gas turbine engine 10 for moving the cleaning medium through the gas turbine engine 10. For instance, the valve(s) 108B and the pressure source(s) 110 (e.g., vacuum source(s)) of the removal system 102B may be controlled (e.g., activated) by the computing device(s) 202 to apply a vacuum pressure to the gas turbine engine 10 to help draw the cleaning medium(s) through and out of the gas turbine engine 10. The removal system 102B may be controlled to generate vacuum pressure for a predetermined amount of time, such as several hours (e.g., four hours), at one or more predetermined intervals, and/or at predetermined pressures (e.g., vacuum pressure of about 1 inch of water, such as between about 0 inches of water (in-H₂O) and about 1 in-H₂O, such as between about 0.1 in-H₂O and about 0.5 in-H₂O, such as about 0.3 in-H₂O, and/or the like). In some instances, the removal system 102B may be controlled to provide vacuum pressure while the delivery system 102A supplies cleaning medium to the gas turbine engine 10. However, in some instances, the removal system 102B may be controlled to begin providing vacuum pressure after the delivery system 102A finishes supplying cleaning medium to the gas turbine engine 10. In further instances, the removal system 102B may be controlled to provide vacuum pressure while the delivery system 102A supplies cleaning medium to the gas turbine engine 10 and continue to provide vacuum pressure after the delivery system 102A finishes supplying cleaning medium to the gas turbine engine 10.

In some instances, once it is determined at (302) that cleaning should begin, the cleaning control algorithm 300 may include controlling the external drive system(s) 118 to rotate the fan 38 of the gas turbine engine. For instance, the external rotation source(s) 120 of the external drive system(s) 118 may be controlled (e.g., activated) by the computing device(s) 202 to rotate the fan 38 at a cleaning speed (e.g., between about 2 revolutions per minute (rpm) and about 500 rpm, such as between about 5 rpm and about 100 rpm, such as between about 10 rpm and about 60 rpm). The external rotation source(s) 120 of the external drive system(s) 118 may be controlled by the computing device(s) 202 to rotate the fan 38 for a predetermined amount of time, such as several hours (e.g., about four hours), at one or more predetermined intervals, and/or at one or more predetermined speeds. In some instances, the external drive system(s) 118 is controlled to rotate the fan 38 while and/or after the delivery system 102A supplies cleaning medium to the gas turbine engine 10. In some instances, the external drive system(s) 118 is controlled to rotate the fan 38 while and/or after vacuum pressure is applied by the removal system(s) 102B.

At (310), the cleaning control algorithm 300 may include determining whether the cleaning process should end. For instance, an input may be received after one or more of the steps (304), (306), (308) is performed, where the input is indicative of whether the gas turbine engine 10, or parts thereof, is now sufficiently clean. In some instances, a rinse operation occurs before such determination. In such instances, the computing device(s) 202 may control the delivery system 102A to direct fluid (e.g., water from reservoir(s) 104) to the gas turbine engine 10, or parts thereof, such that cleaning medium(s) and/or loosened build up remaining in the gas turbine engine 10, or on parts thereof, is removed to allow for clear visibility of the gas turbine engine 10, or on parts thereof, being cleaned. In some instances, the rinse operation is followed by a drying operation to allow for clearer visibility of the gas turbine engine 10, or on parts thereof, being cleaned. For instance, the drying operation may include rotating one or more parts of the gas turbine engine 10 (e.g., controlling the external rotation source(s) 120 to rotate the gas turbine engine 10), controlling the delivery system 102A to direct air through the gas turbine engine 10, or parts thereof, and/or the like.

If no more cleaning is determined to be necessary at (310), then the cleaning control algorithm 300 may proceed to (312) and the cleaning process may end. However, if at (310), it is determined that the cleaning process should not end (e.g., that the gas turbine engine 10, or parts thereof, are not sufficiently clean), then the cleaning control algorithm 300 may return to one or more of the previous cleaning steps (304), (306), (308).

It should be appreciated that either or both steps (306) and (308) may be used to help move the cleaning medium(s) through the gas turbine engine 10 during cleaning. When used in combination, a higher flow rate of the cleaning medium(s) through the gas turbine engine 10 may be possible. When only one of steps (306) or (308) is used, the cleaning system complexity, and thus cost, is reduced. As such, it should be appreciated that, in some instances, the cleaning algorithm 300 includes step (306) without step (308), such that vacuum is applied and the gas turbine engine 10 is not rotated. Conversely, it should be appreciated that, in some instances, the cleaning algorithm 300 includes step (308) without step (306), such that the gas turbine engine 10 is rotated and vacuum is not applied.

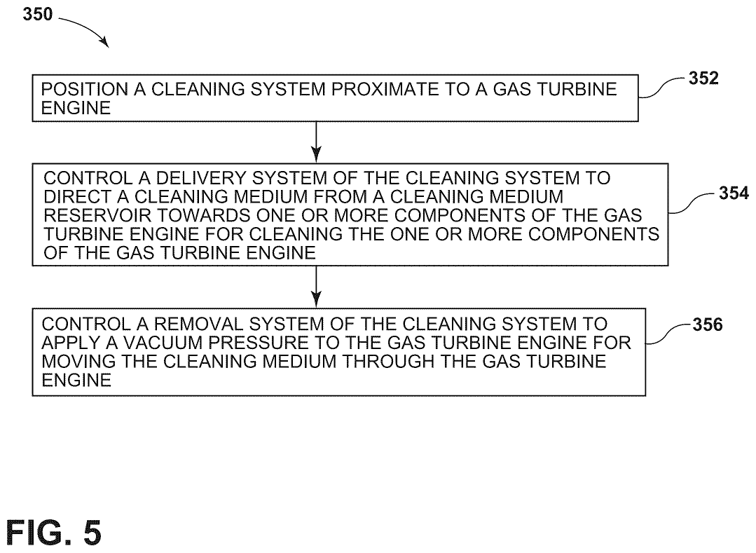

Referring now to FIG. 5, FIG. 5 illustrates a flow diagram of one embodiment of a method 350 for cleaning gas turbine engines in accordance with an exemplary aspect of the present disclosure. In general, the method 350 will be described with reference to the gas turbine engine 10 described with reference to FIG. 1, the cleaning system 100 described with reference to FIG. 2, the computing system 200 described with reference to FIG. 3, and the cleaning control algorithm 300 described with reference to FIG. 4. However, it should be appreciated that the disclosed method 350 may be implemented with gas turbine engines having any other suitable configurations, with computing systems having any other suitable system configurations, and/or with any other suitable control algorithms. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (352), the method 350 may include positioning a cleaning system proximate to one or more components of a gas turbine engine. For instance, as described above, the cleaning system 100 may be positioned proximate one or more components of the gas turbine engine 10 such that the cleaning system 100 may be used to clean the gas turbine engine 10 (e.g., in-situ), or components thereof (e.g., while removed from the gas turbine engine 10). For example, the cleaning system 100 may include one or more injection tubes 105 which may be inserted from the rear end of the gas turbine engine 10, between the outer nacelle 50 and the outer casing 18 for injecting cleaning medium(s) into the inlet 20 from a location rearward of the fan 38, while the cowl(s) are still installed on the gas turbine engine 10 and closed.

At (354), the method 350 may include controlling a delivery system of the cleaning system to direct a cleaning medium from a cleaning medium reservoir towards one or more components of the gas turbine engine for cleaning the one or more components of the gas turbine engine. For instance, as discussed above, the delivery system 102A of the cleaning system 100 may be controlled (e.g., by the computing device(s) 202) to direct at least one cleaning medium from at least one of the cleaning medium reservoirs 104 towards the gas turbine engine 10, or components thereof, to be cleaned. In some instances, the cleaning system 100 may be controlled to direct at least one cleaning medium from at least one of the cleaning medium reservoirs 104 towards the gas turbine engine 10 in-situ.

Additionally, at (356), the method 350 may include controlling a removal system of the cleaning system to apply a vacuum pressure to the gas turbine engine for moving the cleaning medium through the gas turbine engine 10. For example, as described above, the removal system 102B of the cleaning system 100 may be controlled (e.g., by the computing device(s) 202) to generate a vacuum pressure to be applied to the gas turbine engine 10 for moving the cleaning medium through the gas turbine engine 10. In some instances, the removal system 102B may be configured to apply the vacuum pressure without requiring the cowls of the gas turbine engine 10 to be removed.

Further aspects are provided by the subject matter of the following clauses:

The present disclosure provides a system for cleaning gas turbine engines, the system including: a cleaning medium reservoir for storing a cleaning medium; a delivery system configured to direct the cleaning medium from the cleaning medium reservoir towards one or more components of a gas turbine engine for cleaning the one or more components of the gas turbine engine; and a removal system configured to apply a vacuum pressure to the gas turbine engine for moving the cleaning medium through the gas turbine engine.

The system of any preceding clause, wherein the removal system includes: a vacuum source configured to generate the vacuum pressure; and a vacuum interface configured to couple the gas turbine engine to the vacuum source for the vacuum source to apply the vacuum pressure to the gas turbine engine.

The system of at least the preceding clause, wherein the vacuum interface is couplable to a jet exhaust nozzle section of the gas turbine engine, the vacuum interface being configured to move the cleaning medium out of the gas turbine engine through the jet exhaust nozzle section.

The system of any preceding clause, wherein the removal system generates the vacuum pressure at a pressure of from about 0.1 inches of water to about 1 inch of water.

The system of any preceding clause, wherein the delivery system is configured to introduce the cleaning medium into the gas turbine engine while a cowl of the gas turbine engine is still installed on the gas turbine engine and closed.

The system of any preceding clause, further including an external drive system configured to rotate a fan of the gas turbine engine during cleaning of the one or more components of the gas turbine engine, the fan being selectively rotatably coupled to a low pressure shaft of the gas turbine engine.

The system of at least the preceding clause, wherein the external drive system includes: a support frame; a drive motor, the drive motor having a drive shaft, the drive shaft being rotatably supported by the support frame, the drive shaft being rotatable by the drive motor relative to the support frame; and a fan mount, the fan mount rotatably coupling the drive shaft to the fan of the gas turbine engine for rotating the fan during cleaning of the one or more components of the gas turbine engine.

The system of at least the preceding clause, wherein the fan mount has at least two mounting arms, each of the at least two mounting arms being fixedly coupled to a respective fan blade of a plurality of fan blades of the fan.

The system of at least any of the preceding two clauses, wherein the support frame is rotatably fixedly coupled to a fan casing at least partially circumferentially surrounding the fan of the gas turbine engine.

The system of at least any of the preceding three clauses, wherein the drive motor is configured to drive rotation of the fan at a rotational speed below operational speeds of the gas turbine engine.

The system of any of the preceding clauses, wherein the cleaning medium is a foam detergent cleaning medium.

The present disclosure provides a method for cleaning gas turbine engines, the method including: positioning a cleaning system proximate to a gas turbine engine; controlling a delivery system of the cleaning system to direct a cleaning medium from a cleaning medium reservoir towards one or more components of the gas turbine engine for cleaning the one or more components of the gas turbine engine; and controlling a removal system of the cleaning system to apply a vacuum pressure to the gas turbine engine for moving the cleaning medium through the gas turbine engine.

The method of at least the preceding method clause, wherein controlling the removal system includes controlling a vacuum source of the removal system to generate the vacuum pressure, the vacuum source being coupled by a vacuum interface to the gas turbine engine, the vacuum pressure being applied to the gas turbine engine through the vacuum interface.

The method of any preceding method clause, wherein controlling the removal system includes controlling the removal system to generate the vacuum pressure at a pressure of from about 0.1 inches of water to about 1 inch of water.

The method of any preceding method clause, further including: controlling an external drive system to rotate a fan of the gas turbine engine during cleaning of the one or more components of the gas turbine engine, the fan being selectively rotatably coupled to a low pressure shaft of the gas turbine engine.

The method of at least the preceding method clause, wherein controlling the external drive system includes controlling a drive motor to rotate a drive shaft, the drive shaft being rotatably coupled to the fan via a fan mount, the drive shaft being supported for rotation by a support frame.

The method of at least the preceding method clause, wherein positioning the cleaning system proximate to the gas turbine engine includes coupling the fan mount to the fan, the fan mount having at least two mounting arms, each of the at least two mounting arms being fixedly coupled to a respective fan blade of a plurality of fan blades of the fan.

The method of any of at least the two preceding method clauses, wherein positioning the cleaning system proximate to the gas turbine engine includes rotatably fixedly coupling the support frame to a fan casing, the fan casing at least partially circumferentially surrounding the fan of the gas turbine engine.

The method of any of at least the three preceding method clauses, wherein controlling the drive motor to rotate the drive shaft includes controlling the drive motor to rotate the fan at a rotational speed below operational speeds of the gas turbine engine.

The present disclosure provides a gas turbine engine cleaning assembly. The gas turbine engine cleaning assembly including a gas turbine engine, the gas turbine engine including: a high pressure system, the high pressure system including a high pressure compressor rotatably coupled to a high pressure turbine by a high pressure shaft; a low pressure system, the low pressure system including a low pressure compressor rotatably coupled to a low pressure turbine by a low pressure shaft; and a fan, the fan including a fan disk and a plurality of fan blades circumferentially spaced apart from each other on about the fan disk, the fan disk being rotatable, rotation of the fan being selectively coupled to rotate with the low pressure shaft. The gas turbine engine cleaning assembly further including a cleaning system, the cleaning system including: a cleaning medium reservoir for storing a cleaning medium; a delivery system configured to direct the cleaning medium from the cleaning medium reservoir towards one or more components of a gas turbine engine for cleaning the one or more components of the gas turbine engine; an external drive system, the external drive system being configured to rotate a fan of the gas turbine engine during cleaning of the one or more components of the gas turbine engine; and a removal system configured to apply a vacuum pressure to the gas turbine engine for moving the cleaning medium through the gas turbine engine.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for cleaning gas turbine engines, the system comprising:
a cleaning medium reservoir for storing a cleaning medium;
a delivery system configured to direct the cleaning medium from the cleaning medium reservoir towards one or more components of a gas turbine engine for cleaning the one or more components of the gas turbine engine; and
a removal system configured to apply a vacuum pressure to the gas turbine engine for moving the cleaning medium through the gas turbine engine.

2. The system of claim 1, wherein the removal system comprises:
a vacuum source configured to generate the vacuum pressure; and
a vacuum interface configured to couple the gas turbine engine to the vacuum source for the vacuum source to apply the vacuum pressure to the gas turbine engine.

3. The system of claim 2, wherein the vacuum interface is couplable to a jet exhaust nozzle section of the gas turbine engine, the vacuum interface being configured to move the cleaning medium out of the gas turbine engine through the jet exhaust nozzle section.

4. The system of claim 1, wherein the removal system generates the vacuum pressure at a pressure of from about 0.1 inches of water to about 1 inch of water.

5. The system of claim 1, wherein the delivery system is configured to introduce the cleaning medium into the gas turbine engine while a cowl of the gas turbine engine is still installed on the gas turbine engine and closed.

6. The system of claim 1, further comprising an external drive system configured to rotate a fan of the gas turbine engine during cleaning of the one or more components of the gas turbine engine, the fan being selectively rotatably coupled to a low pressure shaft of the gas turbine engine.

7. The system of claim 6, wherein the external drive system comprises:
a support frame;
a drive motor, the drive motor having a drive shaft, the drive shaft being rotatably supported by the support frame, the drive shaft being rotatable by the drive motor relative to the support frame; and
a fan mount, the fan mount rotatably coupling the drive shaft to the fan of the gas turbine engine for rotating the fan during cleaning of the one or more components of the gas turbine engine.

8. The system of claim 7, wherein the fan mount has at least two mounting arms, each of the at least two mounting arms being fixedly coupled to a respective fan blade of a plurality of fan blades of the fan.

9. The system of claim 7, wherein the support frame is rotatably fixedly coupled to a fan casing at least partially circumferentially surrounding the fan of the gas turbine engine.

10. The system of claim 7, wherein the drive motor is configured to drive rotation of the fan at a rotational speed below operational speeds of the gas turbine engine.

11. The system of claim 1, wherein the cleaning medium is a foam detergent cleaning medium.

12. A method for cleaning gas turbine engines, the method comprising:
positioning a cleaning system proximate to a gas turbine engine;
controlling a delivery system of the cleaning system to direct a cleaning medium from a cleaning medium reservoir towards one or more components of the gas turbine engine for cleaning the one or more components of the gas turbine engine; and
controlling a removal system of the cleaning system to apply a vacuum pressure to the gas turbine engine for moving the cleaning medium through the gas turbine engine.

13. The method of claim 12, wherein controlling the removal system comprises controlling a vacuum source of the removal system to generate the vacuum pressure, the vacuum source being coupled by a vacuum interface to the gas turbine engine, the vacuum pressure being applied to the gas turbine engine through the vacuum interface.

14. The method of claim 12, wherein controlling the removal system comprises controlling the removal system to generate the vacuum pressure at a pressure of from about 0.1 inches of water to about 1 inch of water.

15. The method of claim 12, further comprising:
controlling an external drive system to rotate a fan of the gas turbine engine during cleaning of the one or more components of the gas turbine engine, the fan being selectively rotatably coupled to a low pressure shaft of the gas turbine engine.

16. The method of claim 15, wherein controlling the external drive system comprises controlling a drive motor to rotate a drive shaft, the drive shaft being rotatably coupled to the fan via a fan mount, the drive shaft being supported for rotation by a support frame.

17. The method of claim 16, wherein positioning the cleaning system proximate to the gas turbine engine comprises coupling the fan mount to the fan, the fan mount having at least two mounting arms, each of the at least two mounting arms being fixedly coupled to a respective fan blade of a plurality of fan blades of the fan.

18. The method of claim 16, wherein positioning the cleaning system proximate to the gas turbine engine comprises rotatably fixedly coupling the support frame to a fan casing, the fan casing at least partially circumferentially surrounding the fan of the gas turbine engine.

19. The method of claim 16, wherein controlling the drive motor to rotate the drive shaft comprises controlling the drive motor to rotate the fan at a rotational speed below operational speeds of the gas turbine engine.

20. A gas turbine engine cleaning assembly, the gas turbine engine cleaning assembly comprising:
a gas turbine engine, comprising:
a high pressure system, the high pressure system comprising a high pressure compressor rotatably coupled to a high pressure turbine by a high pressure shaft;
a low pressure system, the low pressure system comprising a low pressure compressor rotatably coupled to a low pressure turbine by a low pressure shaft; and
a fan, the fan comprising a fan disk and a plurality of fan blades circumferentially spaced apart from each other on about the fan disk, the fan disk being rotatable, rotation of the fan being selectively coupled to rotate with the low pressure shaft; and
a cleaning system, the cleaning system comprising:
a cleaning medium reservoir for storing a cleaning medium;
a delivery system configured to direct the cleaning medium from the cleaning medium reservoir towards one or more components of the gas turbine engine for cleaning the one or more components of the gas turbine engine;
an external drive system, the external drive system being configured to rotate the fan of the gas turbine engine during cleaning of the one or more components of the gas turbine engine; and
a removal system configured to apply a vacuum pressure to the gas turbine engine for moving the cleaning medium through the gas turbine engine.
